(19) United States
(12) Patent Application Publication
(10) Pub. No.: US 2021/0355955 A1
(43) Pub. Date: Nov. 18, 2021

(54) ROTOR MOUNTING UNIT

(71) Applicant: ebm-papst St. Georgen GmbH & Co. KG, St. Georgen (DE)

(72) Inventors: Volker EHLERS, St. Georgen (DE); Frederick WURSTHORN, Villingen-Schwenningen (DE)

(21) Appl. No.: 17/287,908

(22) PCT Filed: Oct. 30, 2019
(86) PCT No.: PCT/EP2019/079615

§ 371 Date: Apr. 22, 2021

(30) Foreign Application Priority Data
Nov. 23, 2018 (DE) 10 2018 129 608.8

(51) Int. Cl. F04D 29/26; F04D 29/056; F04D 29/053; F04D 17/16

(52) U.S. Cl. CPC F04D 29/263; F04D 17/16; F04D 29/053; F04D 29/056

(57) ABSTRACT

The disclosure relates to a rotor assembly (10) for a high-speed radial fan, comprising an inner, axially open bearing tube (20) in which a shaft (40), carrying a fan wheel (30), is mounted, with a rotor (50) of a canned motor. The bearing tube (20) comprises an outwardly protruding radial projection (21) that extends at least partially beyond the outer circumference (31) of the fan wheel (30).

### FIELD

The disclosure relates to a rotor assembly with fan wheel as well as a radial fan with such a rotor assembly.

### BACKGROUND

In the case of radial fans, the fundamental problem is that a rotor assembly with fan can only be mounted in a housing from one side in an axial direction. This problem exists in particular with radial fans for high-speed applications, which are to be mounted in a one-piece can which is closed axially on one side. Furthermore, there is the problem that the rotor mounting unit must be aligned without imbalance, if at all possible. Balancing, however, is difficult to achieve.

### SUMMARY

High-speed applications within the meaning of the present disclosure are rotational speeds of the fan wheel in which the circumferential speed at the radial compressor outlet is at least 60 m/s.

In this respect, the known solutions from the range of canned pumps using separating can motors, which rotate at a comparatively slow speed, cannot be transferred to high-speed fans.

Insofar as split or multi-part housings, or, for example, a can open on one side, are used, there is always the problem of sealing between the stator and the rotor after mounting the rotor unit. For example, the rotor unit can be assembled completely if the bearing tube is attached as an overmolded component in the primary housing. In this case, however, it is necessary that the can is designed to be open from the rear and therefore has to be closed and sealed after completion of all assembly steps.

Another problem with the assembly of a rotor unit in a can is to grip the rotor unit in such a way and insert it into the completely closed primary housing with the can without straining or damaging the impeller or the bearing system.

Therefore, example embodiments overcome the aforementioned disadvantages and provide a rotor assembly of a radial fan, in particular a high-speed radial fan, which offers an optimized mounting option and allows a balanced support in a sealed can.

The above problems are solved by a technical solution using the combination of features according to claim 1.

According to the example embodiments, a rotor assembly for a radial fan is provided, in particular for a high-speed radial fan, said rotor assembly comprising an inner, axially open bearing tube in which a shaft carrying a fan wheel is mounted, with a rotor of a canned motor, wherein the bearing tube comprises an outwardly protruding radial projection that extends at least partially beyond the outer circumference of the fan wheel.

In such a solution, the ability for balancing, and therefore the balancing of the rotor assembly unit, is significantly improved compared to known assembly methods, and the rotor can be dynamically balanced while fully assembled.

In an advantageous design of the example embodiments, it is provided that the projection is formed as an essentially round plate-shaped projection (holding plate), the diameter DA of which is larger than the diameter DV of the fan wheel. The bearing tube, which contains the rotor bearing, thus comprises a projection with an increased diameter. The diameter of the projection is selected such that it exceeds the diameter of the radial fan wheel. Thus it is possible, among other options, to grip the rotor unit and insert it into a fan housing with a can, which housing is open only in the region of the can and otherwise is completely closed, without straining or damaging the impeller and the bearing system.

It is further advantageous if the projection has an outer circumferential collar which extends in the axial direction and radially surrounds the outside of the radial edge region of the fan wheel at least partially or over the entire circumference. On the one hand, a pot-shaped projection is formed by the raised edge portion, into which the fan wheel can be embedded.

Particularly advantageous is a design in which one or more mounting elements or mounting openings are arranged in an edge region of the projection, which is located radially outside the fan wheel, for attaching the rotor assembly to a fan housing of a radial fan.

It is further advantageous if the mounting elements or mounting openings are arranged in the region of the circumferential collar. The projection is advantageously arranged directly adjacent to the fan wheel under formation of an air gap, whereby an efficient and space-saving design for assembly is achieved.

In a further advantageous design of the example embodiments, it is provided that the shaft is mounted on a first bearing in the bearing tube as well as on a second bearing in the bearing tube, which is located at a distance from the first in the axial direction, in a region between the fan wheel and the rotor.

It is also provided with advantage that the previously described rotor assembly is mounted in a fan housing of a radial fan, wherein the bearing tube, along with the shaft and the rotor mounted on the shaft, is arranged in a circumferentially closed can. In this way, the stator of the canned motor can be installed outside the can in a housing, and the fan wheel can be driven by the canned motor.

In an example embodiment, it is provided that the can is formed integrally with the fan housing. In this way, sealing regions and sealing surfaces are not required and the rotor assembly can be hermetically housed in the fan housing of the radial fan.

It is also advantageous if the can extends away from an essentially flat housing bottom plate of the fan housing in the axial direction, and if the bearing tube is supported (preferably directly) on the housing bottom plate by its radial projection, and further preferably is connected to the fan housing by means of a connection arrangement. The connection arrangement can be realized, for example, by means of a screw connection, a bayonet connection, by means of an adhesive or welded connection or by means of a mechanical connecting means.

Another aspect of the example embodiments relates to a radial fan, in particular a high-speed radial fan equipped with a rotor assembly as described above.

### BRIEF DESCRIPTION OF THE DRAWINGS

Other advantageous refinements of the example embodiments are characterized in the dependent claims and/or are described in more detail through the drawings in conjunction with the description of the example embodiments. In the drawings:

FIG. 1 is a side view of an embodiment of a rotor assembly,

FIG. 2 is a sectional view through the embodiment according to FIG. 1,

FIG. 3 is a sectional view through the embodiment according to FIG. 1, with a fan housing, and

FIG. 4 is a plan view of the rotor assembly according to FIG. 1, and

FIGS. 5, 6, 7, 8 and 9 show further example embodiments.

### DETAILED DESCRIPTION OF EXAMPLE EMBODIMENTS

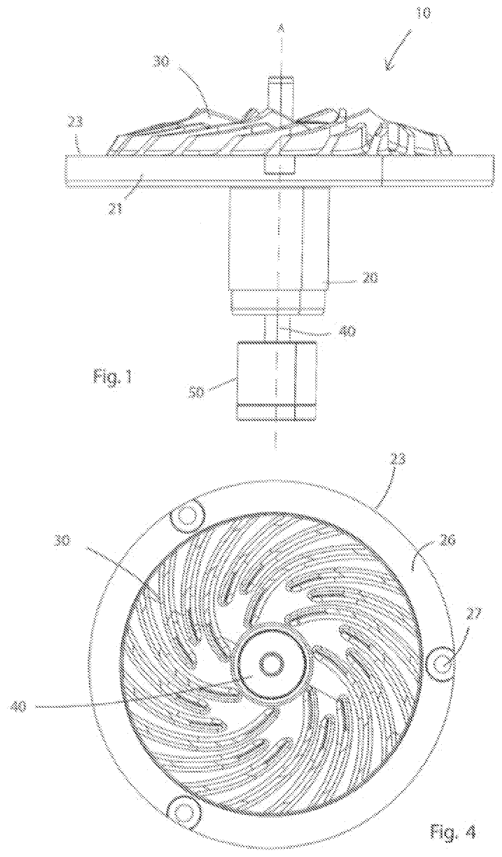

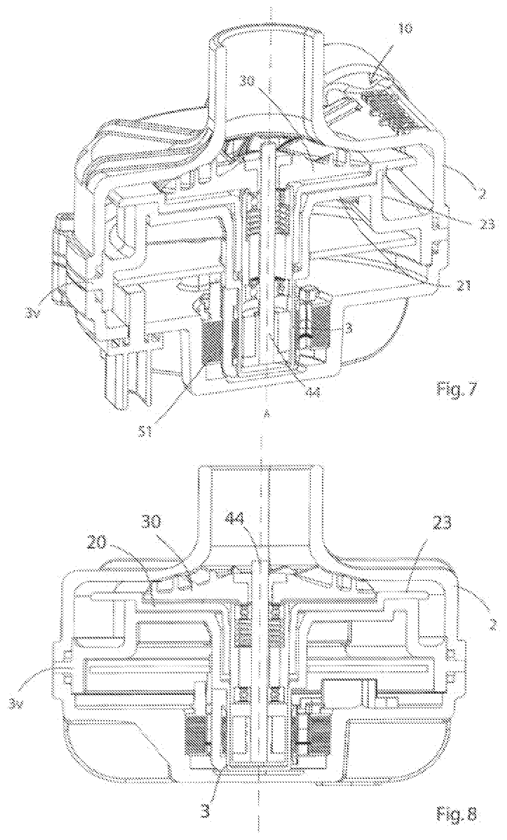

In the following, the example embodiments are described in more detail with reference to FIGS. 1 to 9, wherein identical reference numbers indicate identical structural and/or functional features.

FIGS. 1 to 4 show an embodiment of a rotor assembly 10.

The rotor assembly 10 is designed for a high-speed radial fan. The rotor assembly 10 comprises an inner, axially open bearing tube 20. A shaft 40 is mounted in the bearing tube 20, wherein a rotor 50 of a canned motor is mounted on the shaft 40. The external stator of the motor is not shown in the drawings. The bearing tube 20 has an outwardly protruding radial projection 21.

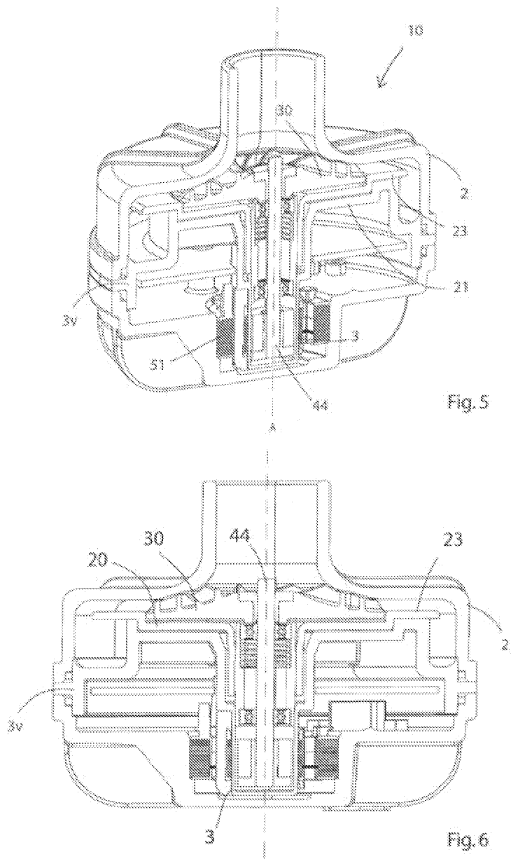

The section view in FIG. 3 clearly shows that the projection 21 extends beyond the outer circumference 31 of the fan wheel 30. The projection 21 is essentially formed as a round plate-shaped projection, the diameter D_{A} of which is greater than the diameter D_{V} of the fan wheel 30.

The projection 21 furthermore has an outer circumferential collar 23 protruding upwards (in FIG. 3), which extends in axial direction A and radially surrounds the outer radial edge region 32 of the fan wheel 30. In other words, the fan wheel 30 is placed on the shaft 40 such that the fan wheel 30 is arranged in the recess in the projection 21.

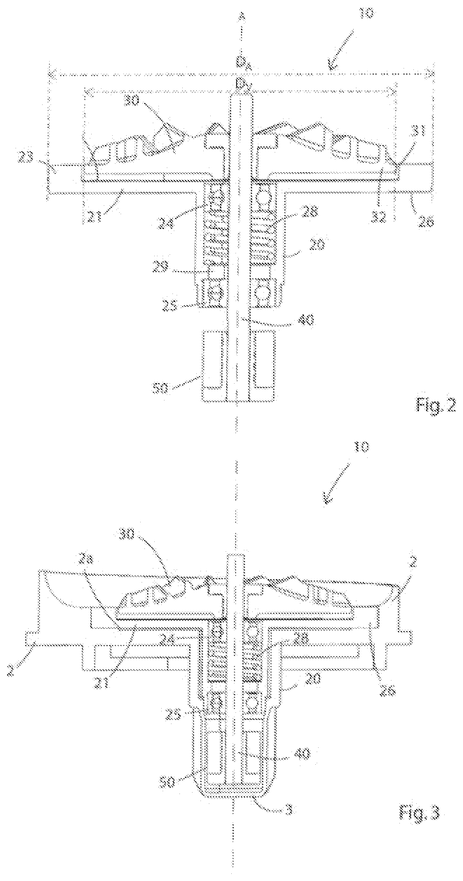

The edge region 26 of the projection 21, which is located radially outside the fan wheel 30, has three mounting openings 27, as shown in FIG. 2. The entire rotor assembly 10 can be attached to a fan housing 2 of a radial fan by means of the mounting openings 27, as shown in FIG. 3. Therein, the three mounting openings 27 are arranged in the circumferential collar 23.

The shaft 40 is mounted between two bearings 24, 25, wherein a spring 28 is pre-tensioned against the first bearing 24, which is supported on an inner gutter 29. The second (in FIG. 3, lower bearing 25) is located at the lower end of the bearing tube 20 and is supported on the gutter 29. The shaft 40 with the rotor 50 protrudes through the lower bearing 25.

The fan housing 2 is also shown in FIG. 3. Therein, the bearing tube 20, along with the shaft 40 and the rotor 50 mounted on the shaft 40, protrudes into a circumferentially closed can 3 (which is open on top), which is part of the fan housing 2 of a radial fan (only partially shown) and is formed integrally with the same.

The can 3 of the housing 2 extends in the axial direction away from an essentially flat housing bottom plate 2a of the fan housing 2.

The bearing tube 20 is supported on the housing bottom plate 2a with its radial projection 21, and is connected to the fan housing 2 by means of a screw connection.

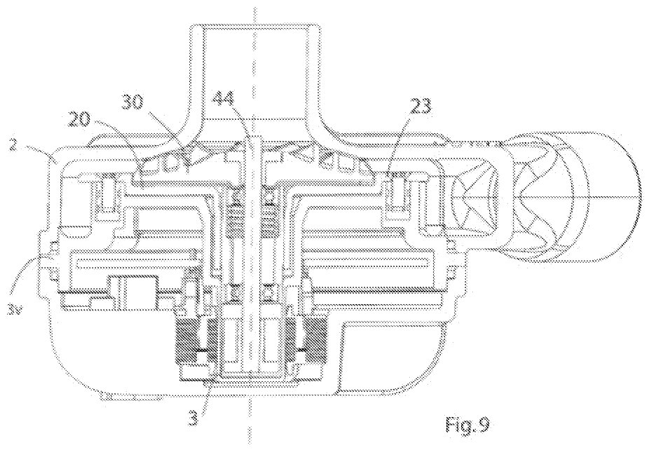

FIGS. 5 to 9 show further embodiments of the disclosure, wherein in particular the design of the housing 2, the can 3, the bearing tube 20 and of the heat dissipation section 23 were executed in an alternative manner. They also show the projection of the can 3v, which extends between a housing top and a housing bottom of the housing 2. FIG. 9 also shows that a mounting opening is provided in the region of the thermal dissipation section 23 for attaching the projection of the bearing tube 20 to the projection of the separating can 3.

The embodiments of the disclosure are not limited to the aforementioned preferred embodiments. Rather, a number of variants are conceivable, which make use of the solution shown here even if they arrive at fundamentally different embodiments. The bearing tube 20 could also be glued to the housing bottom plate 2a, for example.

1. A rotor assembly (10) for a high-speed radial fan, comprising an inner, axially open bearing tube (20) in which a shaft (40), carrying a fan wheel (30), is mounted, with a rotor (50) of a canned motor, wherein the bearing tube (20) comprises an outwardly protruding radial projection (21) that extends at least partially beyond the outer circumference (31) of the fan wheel (30).

2. The rotor assembly (10) according to claim 1, characterized in that the projection (21) is essentially formed as a round plate-shaped projection, the diameter D_{A} of which is larger than the diameter D_{V} of the fan wheel (30).

3. The rotor assembly (10) according to claim 1, characterized in that the projection (21) has an outer circumferential collar (23) which extends in the axial direction and radially surrounds the outside of a radial edge region (32) of the fan wheel (30) at least partially or over the entire circumference.

4. The rotor assembly (10) according to claim 1, characterized in that one or more mounting elements or mounting openings (27) are arranged in an edge region (26) of the radial projection (21), which is located radially outside the fan wheel (30), for attaching the rotor assembly (10) to a fan housing (2) of a radial fan (1).

5. The rotor assembly (10) according to claim 4, characterized in that the mounting elements or mounting openings (27) are arranged in the region of the circumferential collar (23).

6. The rotor assembly (10) according to claim 1, characterized in that the projection (21) is arranged directly adjacent to the fan wheel (30) under formation of an air gap.

7. The rotor assembly (10) according to claim 1, characterized in that the shaft (40) is mounted on a first bearing (24) arranged in the bearing tube (20) and a second bearing (25) arranged in the bearing tube (20), which is located at a distance from the first in the axial direction, in a region between the fan wheel (30) and the rotor (50).

8. The rotor assembly (10) according to claim 1, installed in a fan housing (2) of a radial fan, characterized in that the bearing tube (20), along with the shaft (40) and the rotor (50) mounted on the shaft (40), is arranged in a circumferentially closed can (3).

9. The rotor assembly (10) according to claim 8, characterized in that the can (3) is formed integrally with the fan housing (2).

10. The rotor assembly (10) according to claim 8, characterized in that the can (3) in the axial direction extends away from an essentially flat housing bottom plate (2a) of the fan housing (2), and the bearing tube (20) is supported on the housing bottom plate (2a) with its radial projection (21), and is preferably connected to the fan housing (2) by means of a connection arrangement.

11. The rotor assembly (10) according to claim 10, characterized in that the connection arrangement is realized by means of a screw connection, a bayonet connection, by means of an adhesive or welding connection, or by means of a mechanical connecting means.

12. A radial fan equipped with a rotor assembly (10) as claimed in claim 1.
